(19) United States
(12) Patent Application Publication
(10) Pub. No.: US 2013/0339108 A1
(43) Pub. Date: Dec. 19, 2013

(54) MANAGING DEMAND CHARGE TARIFFS FOR ELECTRIC POWER

(71) Applicants: Geoffrey Ryder, Menlo Park, CA (US); Sui Yan, Mountain View, CA (US); Janaki Kumar, Palo Alto, CA (US); Andreas Vogel, San Francisco, CA (US); Gil Perez, Los Gatos, CA (US); Jens Weitzel, Sunnyvale, CA (US); Stefan Wolf, Gilroy, CA (US); Brian Jones, Lakewood Ranch, FL (US)

(72) Inventors: Geoffrey Ryder, Menlo Park, CA (US); Sui Yan, Mountain View, CA (US); Janaki Kumar, Palo Alto, CA (US); Andreas Vogel, San Francisco, CA (US); Gil Perez, Los Gatos, CA (US); Jens Weitzel, Sunnyvale, CA (US); Stefan Wolf, Gilroy, CA (US); Brian Jones, Lakewood Ranch, FL (US)

(73) Assignee: SAP AG, Walldorf (DE)

(21) Appl. No.: 13/523,424

(22) Filed: Jun. 14, 2012

(51) Int. Cl. G06Q 30/02

(52) U.S. Cl. 705/14.1

(57) ABSTRACT

A method for demand charge management at public charging stations may be provided. The method may comprise collecting information related to electric vehicle (EV) charging from a plurality of interested parties by an infrastructure service cloud, computing charge rate offers based on the collected information by the infrastructure service cloud, transmitting the computed charge rate offers to a driver of an EV by the infrastructure service cloud, and reserving a charge spot for the driver using the infrastructure service when the driver accepts an offer.

### FIELD OF THE INVENTION

The disclosure relates to a system and method for managing demand charge tariffs for electric power, in particular, providing economic energy management for charging electric vehicles at public chargers.

### BACKGROUND

Electric vehicles (EVs) are being designed and manufactured by automobile manufacturers. Electric vehicle charging can be performed at home charging stations or public charging stations. Due to the limited range available with today's electric vehicles, electric vehicle drivers have to rely on both the ability to charge at home as well as away from home at public charging stations.

In some communities in the United States, public charging stations are being offered through government grants that may allow for free or discounted access to encourage electric vehicle purchases. Nevertheless, the public charging stations only have limited existence today. One barrier deterring new public charging stations from being installed are utility tariff structures. Typically, electricity cost for businesses are billed not only based on the total usage for each month but also on their respective peak usage during a month. For example, if a business has a peak usage exceeding a threshold level during a month, a multiplication factor larger than one will be applied to its electricity bill for the month. That is, the business will incur a higher cost for exceeding the threshold level. Thus, if a business installs public charging stations on its premise, the charging operation may cause the electricity usage by the business to exceed a peak usage threshold and force the business to pay a penalty on its electricity cost. To make the matter more complicated, if the business wants to control the charging operation at the public charging stations on its premise, any driver interested in charging at the controlled public charging stations need to get advanced notice before they pull up to charge.

Accordingly, there is a need in the art for providing economic energy management for charging electric vehicles at public charging stations.

### BRIEF DESCRIPTION OF THE DRAWINGS

FIG. 1 is a block diagram of a system for providing economic energy management for charging electric vehicles according to an exemplary embodiment.

FIG. 2 is a sequence diagram for providing economic energy management for charging electric vehicles according to an exemplary embodiment.

FIG. 3 is a block diagram showing information flows of an electrical-vehicle charging management system according to an exemplary embodiment.

FIG. 4A illustrates a user interface (UI) for a driver according to an exemplary embodiment.

FIG. 4B illustrates a user interface (UI) for a driver according to an exemplary embodiment.

FIG. 5 illustrates a user interface (UI) for a retail store according to an exemplary embodiment.

FIG. 6 illustrates a user interface (UI) for a retail cloud according to an exemplary embodiment.

FIG. 7 illustrates a user interface (UI) for a EV service provider cloud according to an exemplary embodiment.

FIG. 8 illustrates a user interface (UI) for a utility cloud according to an exemplary embodiment.

FIG. 9 illustrates a user interface (UI) for a OEM cloud according to an exemplary embodiment.

FIG. 10 illustrates electricity usage with demand charge management according to an exemplary embodiment.

FIG. 11 illustrates a flow chart of a process for providing economic energy management for charging electric vehicles according to an exemplary embodiment.

FIG. 12 illustrates a computing device for providing economic energy management according to an exemplary embodiment.

### DETAILED DESCRIPTION

Embodiments of the present invention may provide economic energy management for charging electric vehicles at public charging stations. On embodiment may provide a method to provide demand charge management at public charging stations. The method may comprise collecting information related to electric vehicle (EV) charging from a plurality of interested parties by an infrastructure service cloud, computing charge rate offers based on the collected information by the infrastructure service cloud, transmitting the computed charge rate offers to a driver of an EV by the infrastructure service cloud, and reserving a charge spot for the driver using the infrastructure service when the driver accepts an offer.

Embodiments of the present invention may encourage more charging station deployments by managing demand charges. The demand charge management policy may be implemented through cloud-based services. In one embodiment, given a specific address, a cloud-based infrastructure service may (a) inform the driver of the allowed charging level at the specific address before the driver arrives, and (b) enforce that charging level through cloud-based communication to the electric vehicle and to networked EV charging stations located at that address.

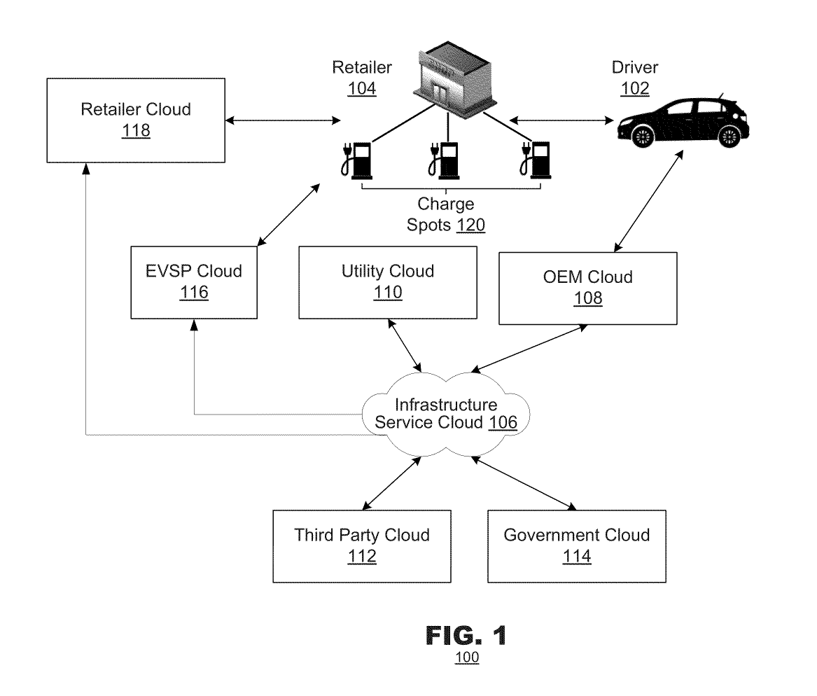

FIG. 1 illustrates a system 100 for providing economic energy management for charging electric vehicles according to an exemplary embodiment. The system 100 may comprise a driver (D) 102 driving an electric vehicle, a retailer (R) 104 that may have a plurality of charge spots (E) 102, a retailer cloud (RC) 118, an electric vehicle service provider (EVSP) cloud (EV) 116, a utility cloud (UC) 110, an original equipment manufacture (OEM) cloud (OC) 108, a third party cloud (TPC) 112, a government cloud (GC) 114 and an infrastructure service cloud (SC) 106.

The driver 102 may represent a plurality of drivers that drive electric vehicles. The driver 102 may drive the electric vehicle around and request charging at public charge stations. The electricity to be consumed for charging the electric vehicle at a public charge station may be referred to as demand charge. The retailer 104 may be a small store or franchisee that hosts public charge spots 120. The retailer 104 may represent a plurality of retailers under control by a retailer chain. The retailer cloud 118 may be a computer network for the retailer's parent organization (e.g., the retailer chain). The parent organization may partly determine policy for the retailer 104. The retailer cloud 118 may represent a plurality of retailer organizations that each may have a plurality of retailer stores like the retailer 104. Each of the charge spots 120 may be a networked charging station that may be monitored and remote-controlled. The EVSP cloud 116 may represent a network server of the EVSP that directly controls charging stations. The utility cloud 110 may represent a local utility's network computer servers. These computer servers may hold energy usage information, and compute official demand charges.

The OEM cloud 108 may represent a computer network for the vehicle manufacture or the dealer of the electric vehicle driven by the driver 102. The OEM cloud 108 may communicate with the vehicle by wireless communication. In one or more embodiments, the OEM cloud 108 may comprise network servers belonging to the driver's OEM brand and the OEM may control the communication with the electric vehicle drive by the driver 102 such that all communication may go through the OC 108.

The TPC 112 may comprise a computer network of a third party that may be interested in allowing D 102 to access E 104, and may reimburse demand charges. The GC 114 may be a computer network of a government entity that may track energy supplied by E, and tax it, or issue credits for it. The SC 106 may be a cloud-based computing platform that provides services to and routes data from all the other entities. In the system 100, each of the clouds may comprise a plurality of interconnected computing devices, including, for example, computer servers, terminals, data storage devices.

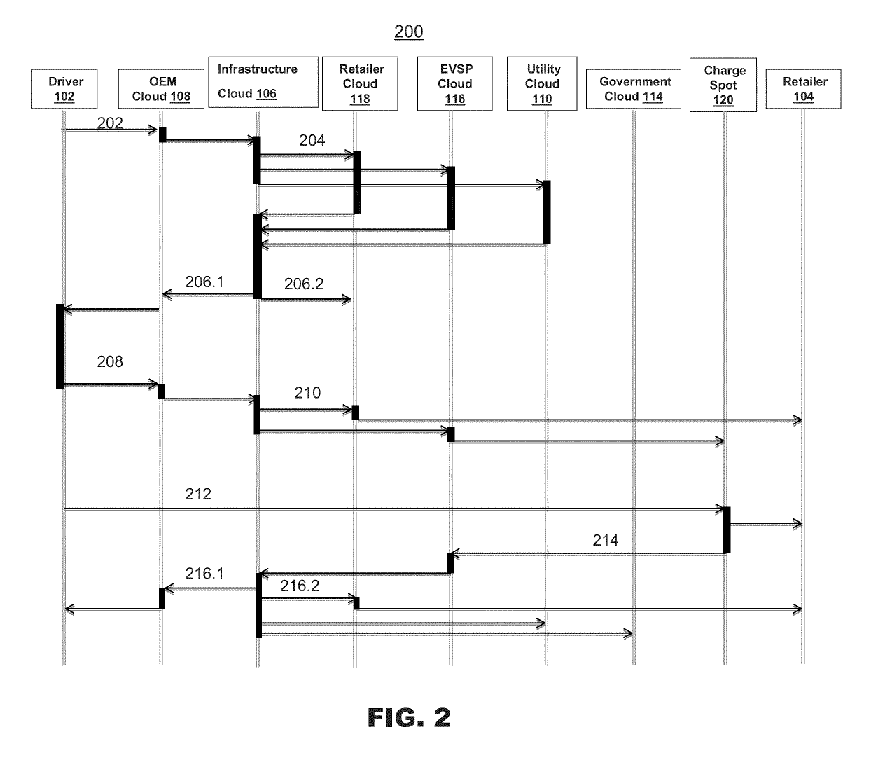

FIG. 2 illustrate a sequence 200 for providing economic energy management for charging electric vehicles according to an exemplary embodiment. The driver 102 may wish to charge an electric vehicle at a charge spot 120 installed at the retailer 104. At 202, the driver 102 may asks for availability and price of charging at the charge spot 120. As described above with respect to FIG. 1, the request from the driver 102 may be transmitted from the electric vehicle driven by the driver 102 to the OEM cloud 108, which may forward the request to the SC 106. At 204, the SC 106 may pull information from the RC 118, EC 116 and UC 110, and compute a demand charge price (P_D). For example, the SC 106 may pull electricity price information from the UC 110, schedule information for charge spots (including information for all charge spots 120 at the retailer 104) from the EC 116, and/or customer profitability information and non-EV electricity usage for the retailer 104 from the RC 118. The profitability information may define an empirically estimated probability distribution characterizing the probability that this customer's purchases contribute a specific amount to the retailer's profit margins. Customers whose expected profitability value is high may be given more generous P_D offers by the retailer. A generous offer may mean a higher rate of charge, a longer time duration of charge, and/or bigger discounts on the store's products and services than other drivers receive.

At 206.1 and 206.2, the SC 106 may inform the driver 102 (via the OC 108) and RC 118 of the offer P_D. At 208, the driver 208 may send (via the OC 108) an acceptance of the offer to the SC 106. At 210, the SC 106 may reserve the charge spot 120 at the EC 116, which may send a reservation notice to the charge spot 120. Also, the SC 106 may notify the RC 118, which may in turn notify the retailer 104 that a charge spot 120 at the retailer 104 has been reserved. At 212, the driver 102 may charge the electric vehicle at the charge spot 120 while going into the retailer 104 to purchase goods or services. At 214, 6. the charge spot 120 may report the charging session ended to the EC 116, which may report to the SC 106. At 216.1, the SC 106 may notify the driver 102 (via the OC 108) of the final duration and price of the charging event. And at 216.2, the SC 106 may notify other parties (e.g., the UC 110, GC 114, RC 118 and the retailer 104) of the event, for their records. In one embodiment, the driver may be receive a financial charge that may be consolidated into a monthly bill.

In one or more embodiment, the sequence 200 may cover back-end interactions among the parties shown in the system 100 of FIG. 1 in order to allow charging. At the same time, the system 100 may use the sequence 200 to accomplish other goals: (a) avoiding increased demand charges in the retailer 104's utility bill, and/or (b) allowing interested third parties to compensate the retailer 104 for the demand charges incurred. The system 100 may provide connection to multiple parties through the SC 106's cloud service. The sequence 200 may facilitate information flows to inform the driver and all interested parties to coordinate optimal activity. The SC 106 may include analytics engines to compute optimal policies for all the parties.

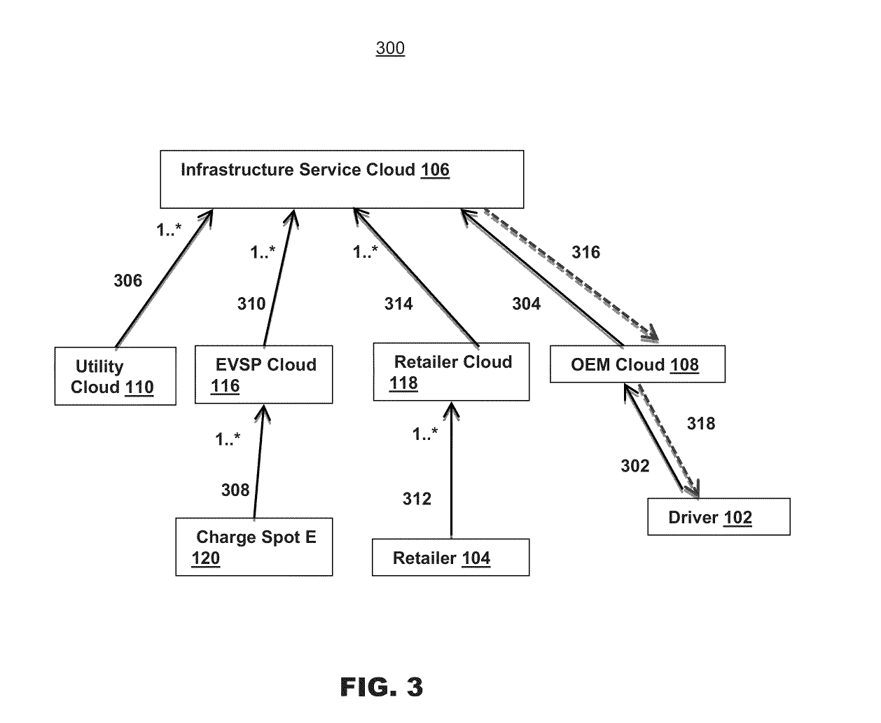

FIG. 3 is a block diagram showing information flows of the system 100 according to an exemplary embodiment. As shown in FIG. 3, the arrow 302 may indicate the driver 102 may send information to the OEM cloud 108. For example, the driver 102 may request reservation of a charge spot when driving through a neighborhood and request for P_D offers to choose from. The request may be forwarded by the OEM cloud 108 to the infrastructure service cloud 106 as indicated by the arrow 304.

The infrastructure service cloud 106 may collect information from the utility cloud 110 as indicated by the arrow 306, from the ESVP cloud 116 as indicated by the arrow 310 and from the retailer cloud 118 as indicated by the arrow 314. For example, the infrastructure service cloud 106 may collect electricity prices from a plurality of utilities via one or more utility cloud 110. Further, the infrastructure service cloud 106 may collect scheduling information for charge spots in the neighborhood from a EV service provider via the ESVP cloud 116. Each ESVP cloud 116 may check availability of all charge spots E 120 under its control (e.g., busy or free, is there reservations, etc.). The retailer cloud 118 may collect non-EV electricity usage information from the retailer 104, for example, by the arrow 312. The infrastructure service cloud 106 may check customer profitability and non-EV electricity usage of the retailer 104 via the retailer cloud 118. In one embodiment, the infrastructure service cloud 106 may compute one or more P_D offers based on the collected information. The information collected by the infrastructure service cloud 106's may be pulled by the infrastructure service cloud 106 and/or pushed from the utility cloud 110, the ESVP cloud 116 and the retailer cloud 118.

Based on the collected information, the infrastructure service cloud 106 may compute one or more offers of P_D and send to the OEM cloud 108, e.g., as indicated by the arrow 316. The OEM cloud 108 may relay these offers to the vehicle and driver 102, e.g., as indicated by the information flow arrow 308.

In one embodiment, the whole information collection, P_D computation, request and response process may be automated. For example, when the electric vehicle enters a neighborhood, the location information may be pushed from the vehicle to the infrastructure service cloud 106 via the OEM cloud 108. The infrastructure service cloud 106 may compute a plurality of P_D offers and then automatically choose one for the driver.

In one embodiment, a store may use location based (LBS) data from OC to tweak its offers, for example, set aside P_D, and make nice P_D offers to VIPs that are passing by. In one embodiment, a store may use location-based data from OC to know that certain drivers are nearby, and then match those drivers' identities with the store's collected customer profitability data. After doing the matching the retailer may know the expected profitability value of these nearby drivers, and make the most generous offers in real time to the most profitable drivers among them as they approach the store. The retailer may choose to let properly constrained automated P_D computations generate the P_D offers most of the time, without manual intervention.

However, not all situations faced by the store manager can be captured in the automated calculations. For example, an inoperable vehicle or a fallen tree may temporarily block access to charging stations in a way that is visible to the store manager, but may not be captured by automated sensors. In such a case the store manager may manually stop P_D offers for the blocked stations from being sent. Or, a data processing error may grossly overestimate the profitability of a given customer, in a way that is obvious to the store manager, requiring a manual reduction of the P_D offer that would otherwise be sent.

Each arrow in FIG.3 labeled “1 . . . *” may designate a many to one relation along the direction of the arrow. Thus, the infrastructure service cloud 106 may collect information from more than one utility cloud 110, more than one EC 116, and/or more than one RC 118. That is, more than one utility companies, more than one EV service providers, more than one retail organizations may be used to provide a best offer P_D to the driver in the neighborhood.

In one embodiment, manual operation may be needed by the driver 102 and a store manager at the retailer 104 to complete a transaction. The UI for the driver 102 and store manager at the retailer 104 will be illustrated and described below.

In one embodiment, multiple P_D offers may be provided to D. Those P_D offers may be relevant to the driver 102's trip and destination, and the driver 102 may select the one best fit his need.

In one embodiment, the driver 102 may set a control that allows the OC 108 to provide the vehicle's location to nearby stores, and continually collects P_D offers from multiple retailers within a convenient distance. That, is each store may generate responsive P_D offers to present to the driver 102 as the driver 102 passes by (e.g., after looking up the driver 102's value as a customer in the retailer cloud 118).

In one embodiment, the infrastructure service cloud 106 as shown in FIG. 3 may handle multiple drivers; and even multiple OEM Clouds handling requests and offers from multiple drivers from different OEM clouds. In this embodiment, the UI for a store manager at the retailer 104 may organize and present all that information from many different OEM's drivers to the store manage to decide how to make P_D offers to different drivers.

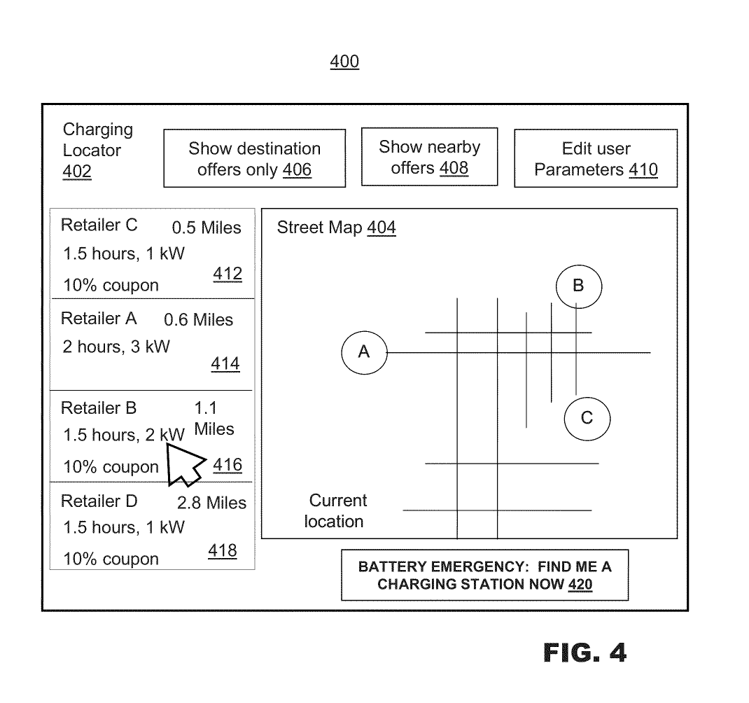

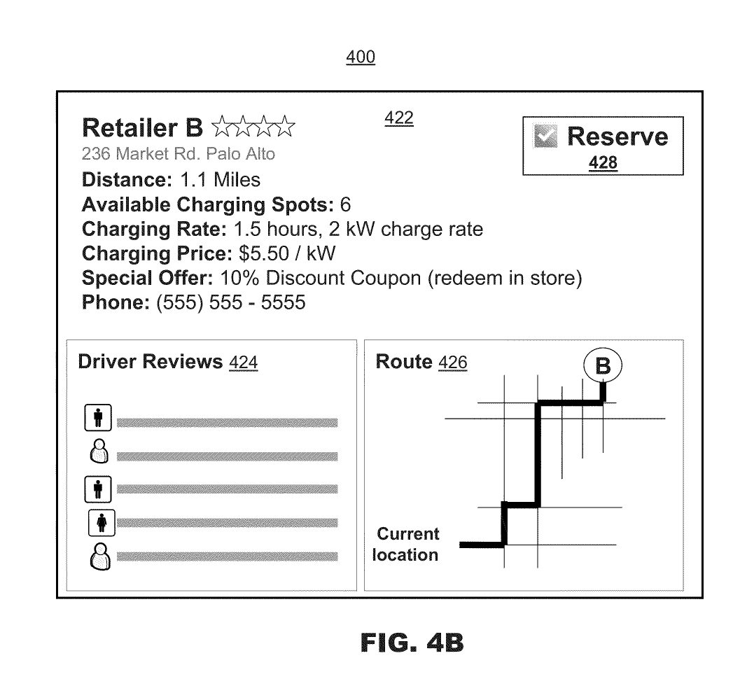

FIG. 4A illustrates a user interface (UI) 400 for a driver according to an exemplary embodiment. The UI 400 may be presented on a car center console screen, a mobile device or a web page on a PC (e.g., a web portal). The UI 400 may include a charging locator screen 402, which may be an overview of all public charging stations nearby or at a destination of the driver. The charging locator screen 402 may include a street map 404, a show destination offers only button 406, a show nearby offers button 408, a edit user parameters button 410, an battery emergency button 420 and a list of display panels 412, 414, 416 and 418 for public charging stations at retailers C, A, B and D respectively. The battery emergency button 420 may allow the driver to find a closest charging station when the EV battery is low. The retailers may be displayed in a list sorted by some criteria (e.g., by distance), which may be changed by the driver to other sorting parameters, such as price, etc. The show destination offers button 406 may produce a view for the driver of P_D offers from retailers within a limited distance of the destination (e.g., within a comfortable walking distance of the destination). The show nearby offers button 408 may produce a view for the driver of P_D offers from retailers within a close proximity to where the vehicle is passing at that moment. The edit user parameters button 410 may allow the driver to manipulate the numerical settings that govern the activity of the UI controls. For example, one of the editable parameters may be a cutoff radius defining the limited distance used when the show destination offers button 408 may be clicked.

In one embodiment, the UI 400 may be configured to show a leader board to a driver where the driver may compete (e.g., via social media groups) with his friends on some EV related key performance indicators (KPIs), such as CO2 saved, discount coupon redeemed, and “check-in” places.

In the example shown in FIG. 4A, retailers A, B, C and D may meet the driver's requirements, for example, the right type of retail location for this driver's shopping trip, that have public charging stations installed. The UI 400 may show the offers P_D from each of A, B, C and D to the driver, so that the driver can choose an offer best fit the driver's need. For example, as shown in the display panel 414, retailer A may have an offer of 2 hours at a 3 kW charge rate; as shown in the display panel 416, retailer B may have an offer of 1.5 hours at a 2 kW charge rate, plus a 10% discount coupon for the store; as shown in the display panel 412, retailer C may have an offer of 1.5 hours at 1 kW charge rage, plus a 10% discount coupon for the store; and as shown in the display panel 418, retailer D may have an offer of 1.5 hours at 1 kW charge rage, plus a 10% discount coupon for the store. Each of the display panel 412, 414, 416 and 418 may be clickable, and the driver may click any one of them to view further detail.

FIG. 4B illustrates a user interface (UI) 422 for a driver according to an exemplary embodiment. The UI 422 may show details of the particular retailer B when the driver clicks the display panel 416 on the UI 400. The UI 422 may replace the charging locator screen 402 to show more detail information and navigation information of how to get there. In FIG. 4B, the UI 422 may show details of the retailer B of the charging locator screen 402, a button 428 to reserve a charge spot at the retailer B, a display of other driver reviews 424, and a map 426 showing the direction to the retailer B. The details of the retailer B may include ratings (e.g., by other users or some industry association bodies) indicated by stars, street address, distance to the driver's current location, number of available charge spots, charging rate, charging price, special offer (e.g., 10% discount coupon) and a contact phone number.

In one or more embodiment, the charging locator screen 402 and user interface (UI) 422 may be configured to refresh manually, or refresh automatically and continuously with new location offers as the driver passes by.

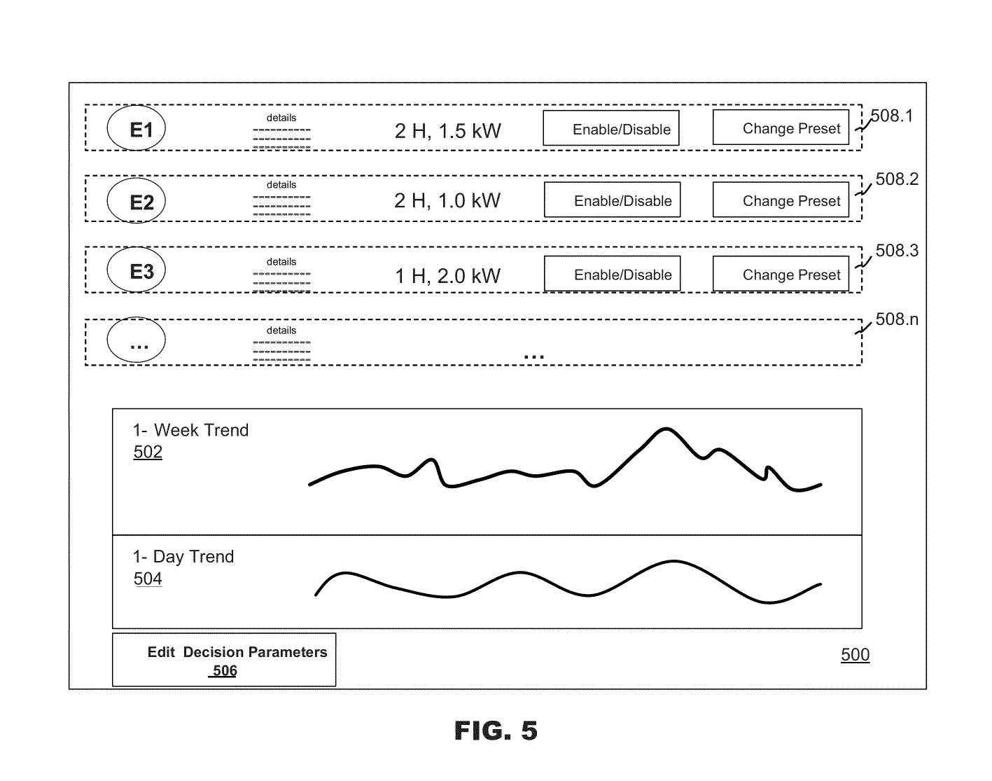

FIG. 5 illustrates a user interface (UI) 500 for a retail store according to an exemplary embodiment. The UI 500 may comprise a one-week trend of electricity usage 502, a one-day trend of electricity usage 504, an edit button 506 to allow a retail store staff to change decision parameters, and a plurality of charge spot displays 508.1˜508.n (n being an integer larger than one). The electricity usage displays 502 and 504 may visually show the retailer (e.g., a store staff) the trend of electricity usage so the retailer can manage the electricity usage to be within a threshold level and thus, avoid paying a penalty for exceeding the threshold level. Each of plurality of charge spot displays 508.1˜508.n may show an identifier of the respective charge sport, detailed information about this respective charge spot, charging rate provided at the respective charge spot, an enable/disable button that toggles whether new offer may be automatically pushed to drivers if the respective charge spot is vacant and a change preset button that allows a store manager to manually override preset parameters as described above. The edit button 506 may allow the retailer to enter decision parameters at an edit screen. The decision parameters may be quantities/constraints that affect the retailer's participation in the P_D computation process.

In one embodiment, the UI 500 may be a shown at the retailer 104. When the infrastructure service cloud 106 continually accepts new driver requests for charging station reservations, the retailer 104 may push out P_D offers to nearby drivers automatically for charge spots that are vacant when this is enabled.

In one embodiment, a manager at the retailer's parent organization may restrict the control options at a retailer. For example, sometimes a manager/operator may not be on the premise at the retailer, and at those times an operator at the retailer cloud may take over on behalf of the retailer as described below.

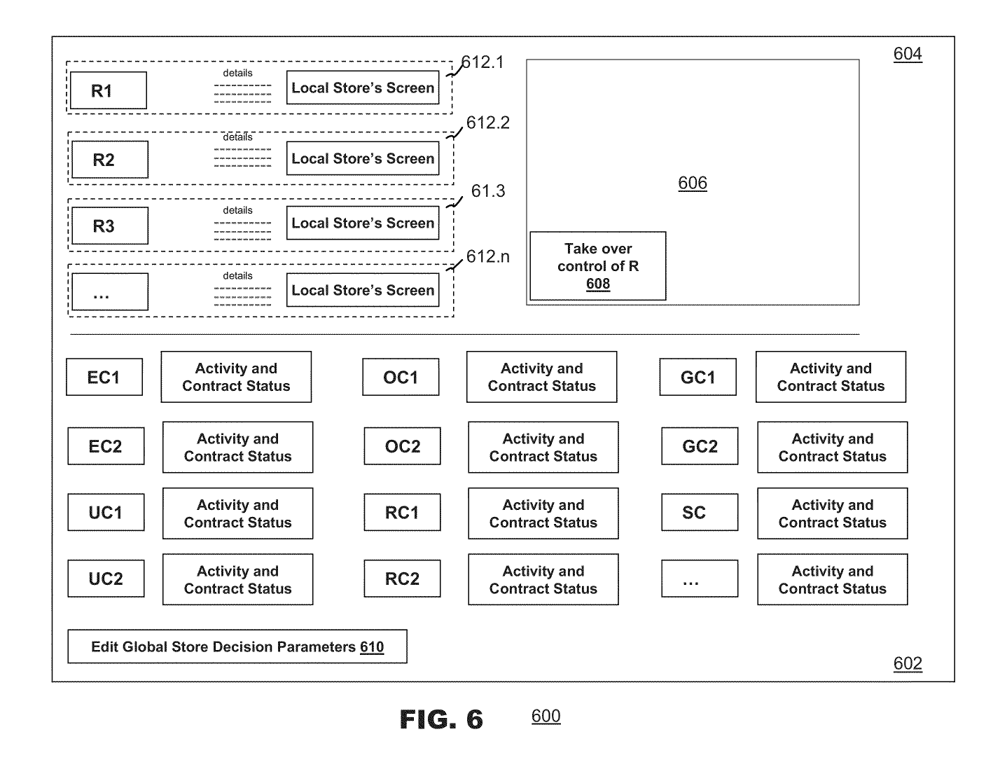

FIG. 6 illustrates a user interface (UI) 600 for a retail cloud according to an exemplary embodiment. The UI 600 may comprise two display panels 602 and 604. The display panel 602 may comprise an edit button 610 and a plurality of business partners. The plurality of business partners may include, for example, EVSP clouds (EC1 and EC2), OEM clouds (OC1 and OC2), utility clouds (UC1 and UC2), other retailer clouds (RC1 and RC2), government cloud (GC1 and GC2), and the infrastructure service cloud (SC). Each business partner displayed may be accompanied by a button that when clicked, shows activity and contract status for the selected business partner. The edit button 610 may allow the retailer cloud to enter decision parameters at an edit screen. The decision parameters may be quantities/constraints that affect the retailer cloud's participation in the P_D computation process.

The display panel 604 may comprise a plurality of the retail stores displays 612.1˜612.n (n being an integer larger than one) and a screen 606 to display a currently selected retail store's UI screen (e.g., a full view of the UI 500). Each of the plurality of retail stores displays 612.1˜612.n may show an identifier of the respective store, detailed information about this respective store, a button to select the store's local screen to be viewed in the screen 606. The screen 606 may include a button 608 to allow an operator at the retailer cloud using the UI 600 to take over control the control of the retailer.

In one embodiment, the retailer cloud may be represent the computer network of the retailer organization that is the majority owner of the retailer, or a key stakeholder for some retailer that are franchisees.

In one embodiment, the retailer organization may have contracts with other entities for shared services: with utilities UC for energy prices, with EC for EV charging services, with OC for special deals for their drivers, with governments GC for taxing and regulatory compliance, and so on. All these entities affect retailer's ability to make P_D offers. The UI 600 may allow the retailer organization managers to view—and where possible react to—updates of these partner entities' activities.

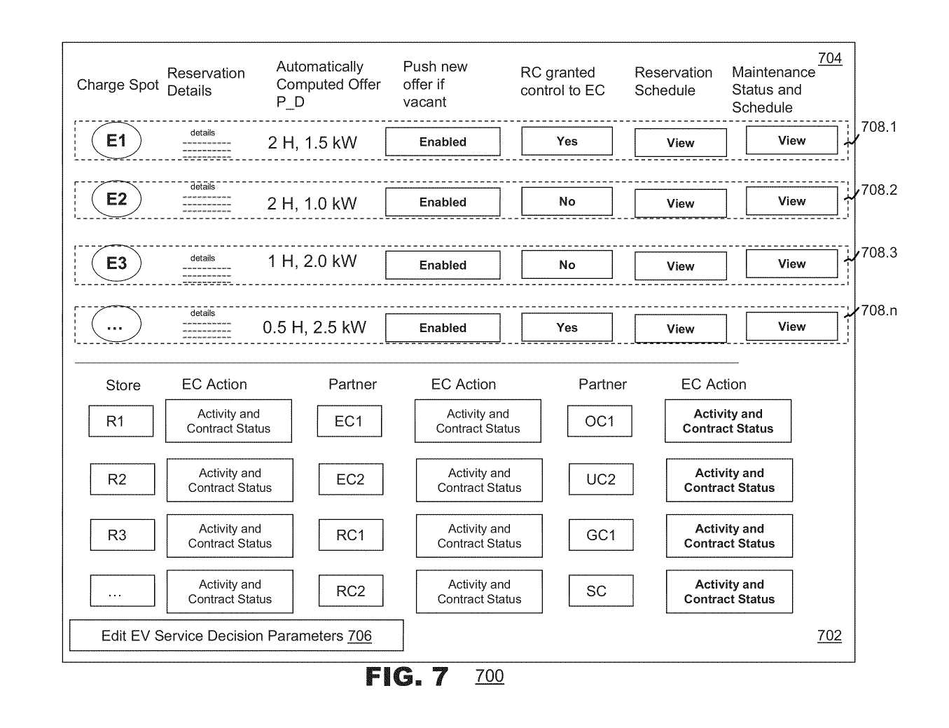

FIG. 7 illustrates a user interface (UI) 700 for a EV service provider cloud according to an exemplary embodiment. The UI 700 may comprise two display panels 702 and 704. The display panel 704 may comprise an edit button 706, a plurality of stores that have charge spots and a plurality of business partners. The plurality of stores may include retailers R1, R2, R3, etc. The plurality of business partners may include, for example, EVSP clouds (EC1 and EC2), OEM clouds (OC1), retailer clouds (RC1 and RC2), utility clouds (UC1 and UC2), government cloud (GC1) and the infrastructure service cloud (SC). Each store and business partner displayed may be accompanied by a button that when clicked, shows activity and contract status for the selected store or business partner. The edit button 706 may allow the EV service provider to enter decision parameters at an edit screen. The decision parameters may be quantities/constraints that affect the EV service provider's participation in the P_D computation process.

The display panel 704 may comprise a plurality of the charge spot displays 708.1˜708.n (n being an integer larger than one). Each of the plurality of charge spot displays 708.1˜708.n may show an identifier of the charge spot, detailed information about this charge spot, an automatically computed offer P_D for the charge spot, an enable/disable button to enable or disable whether pushing new offer to drivers if the charge spot is vacant, a display label showing whether the retailer cloud has granted the control of the charge spot to the EV service provider, a button to show reservation schedule of the charge spot and a button to show the maintenance status and schedule information of the charge spot.

In one embodiment, the EV service provider may be a specialized service provider that helps retailers manage their networked charge spots. The UI 700 may be used by the EVSP cloud 116 to participate in the system 100.

In one embodiment, the infrastructure provided by infrastructure service cloud 106 allow many to many relationships. Thus, the EVSP cloud 116 may work together with other EC to bring a portfolio of services to a particular retailer and/or retailer cloud. For example, the UI 700 shows EC1 and EC 2 as partners. EC1 may have better network coverage in the retailer's location, EC1 and EC2 may have stations there, and EC2 may rely on EC1 for networked communication. In one embodiment, each EC may maintain a master schedule for all charge spots it is responsible for. The EC may provide views of this master schedule to the retailer cloud, retailer, and others as needed. Further, EC may also manage maintenance of the charge spots. In one embodiment, the RC may choose to outsource some or all of the RC UI functions to EC.

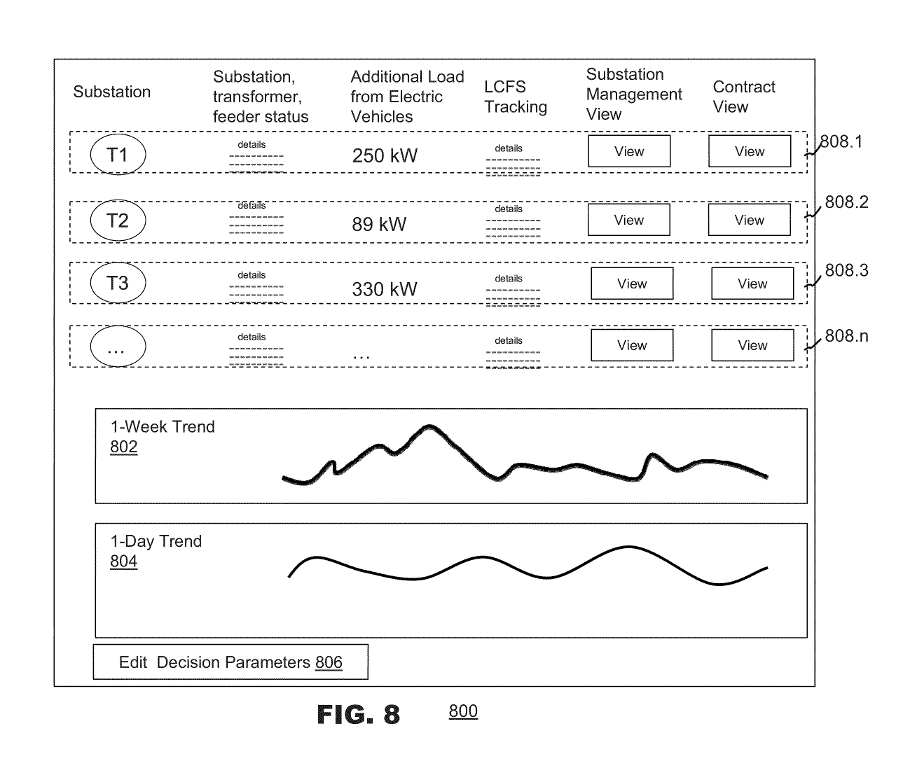

FIG. 8 illustrates a user interface (UI) for a utility cloud according to an exemplary embodiment. The UI 800 may comprise a one-week trend of electricity usage 802, a one-day trend of electricity usage 804, an edit button 806 to allow a utility company staff to change decision parameters, and a plurality of substation displays 808.1˜808.n (n being an integer larger than one). The electricity usage displays 802 and 804 may visually show the trend of electricity usage at a selected substation. The trend may be for one transformer, several transformers and feeders, a substation transformer, or even multiple substations depending on a zoom level of the UI control. The utility company may wish to judge the right demand charge to levy in specific situations after observing trends at one or more of those levels of aggregation. The edit button 806 may allow a utility company operation to enter decision parameters at an edit screen. The decision parameters may be quantities/constraints that affect the utility company's participation in the P_D computation process.

Each of plurality of substation displays 808.1˜808.n may show an identifier of an electricity substation, detailed information about this substation (e.g., transformer, feeder status), additional load from EVs at the substation, low carbon fuel standard (LCFS) tracking detailed information, a button to show substation management view, and a button to show the contract view of the substation.

In one embodiment, the UI 800 may be shown at the utility cloud 110. The utility cloud 110 may provide energy prices and the demand charge to influence the retailer's P_D offers based on the economics of local power grid constraints. Further, the utility cloud 110 interface UI 800 may show the effect of the driver's charging at the charge spot, at the retailer, and on the grid. The utility cloud 110 may force energy use reduction through grid controls shown in the substation management view button for each substation 808.1˜808.n. In one embodiment, the utility company may receive low carbon fuel credits for EV charging activity, which might offset or lower demand charges, and improve retailer's P_D offer.

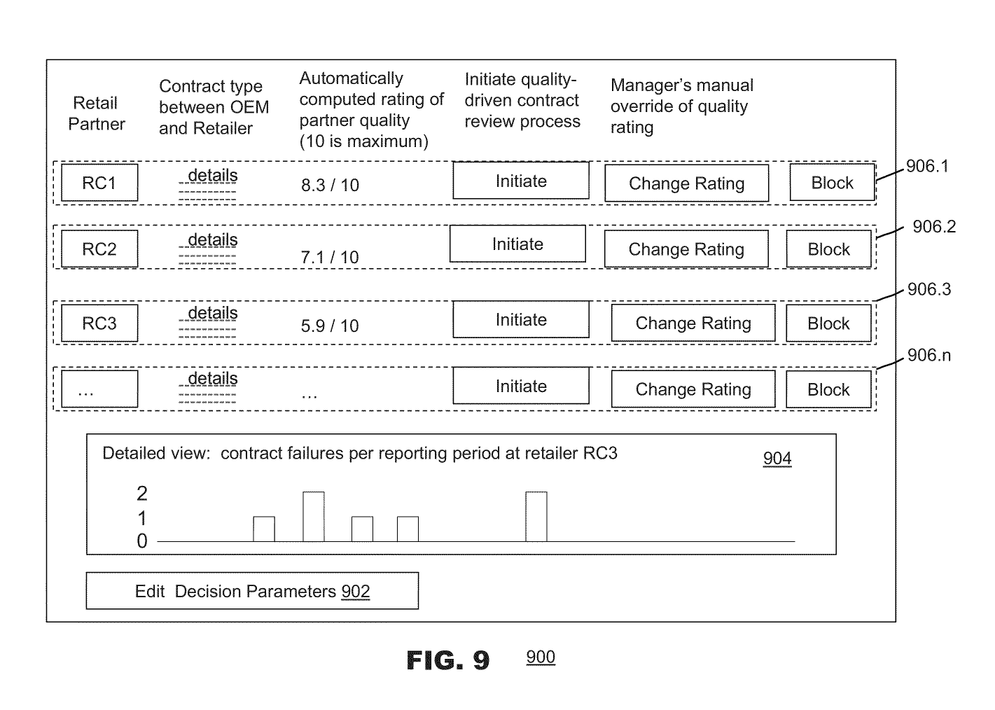

FIG. 9 illustrates a user interface (UI) 900 for a OEM cloud according to an exemplary embodiment. The UI 900 may comprise an edit button 902 to allow an OEM cloud operator to change decision parameters, a detailed view 904 of contract failures per reporting period at a selected retailer chain (e.g., represented by a retailer cloud), and a plurality of retailer clouds 906.1˜906.n. Each of the plurality of retailer clouds 906.1˜906.n may show an identifier of the respective retailer chain, detailed information about contract type between the OEM and the retailer chain, an automatically computed rating of the partner quality, a button to initiate quality-driven contract review process, a button to allow a manager to manually override the quality rating and a button to block all transmission of driver's personal information. The edit button 902 may allow the OEM to enter decision parameters at an edit screen. The decision parameters may be quantities/constraints that affect the OEM's participation in the P_D computation process.

In one embodiment, the UI 900 may be a shown at the OEM cloud 108. The OEM may use the UI 900 to provide all its drivers a convenient charging experience. The OEM Cloud 108 may balance convenience with its drivers' privacy. The OC 108 may relay messages from drivers to the infrastructure service cloud 106, but the level of transmitted metadata about the driver (name, VIN #, contact info, habits and spending profile) may depends on the type of contracts both the driver and the OEM have with the retailer chain and EV service provider. In one embodiment, if the OC 108 has reason to believe the driver's privacy settings/agreements are not being honored, a manager at the OC 108 can block personal information about the driver from being sent to the retailer cloud 118.

In one embodiment, the OC 108 may collect feedback from its drivers about P_D offers, charge spot reservations, and other information (e.g., retailer chains, retailer stores, EV service providers, charge spots that have a history of problems (reservations not honored, broken equipment, overcharged on price)). Future P_D offers transmitted to the driver through the OC 108 may be rated by the OC 108 according to how well the involved parties have honored their past P_D offers.

In one embodiment, a manager at the OC 108 can override, via the UI 900, automatically generated ratings if the manager becomes aware of external, relevant information not built in to the rating system.

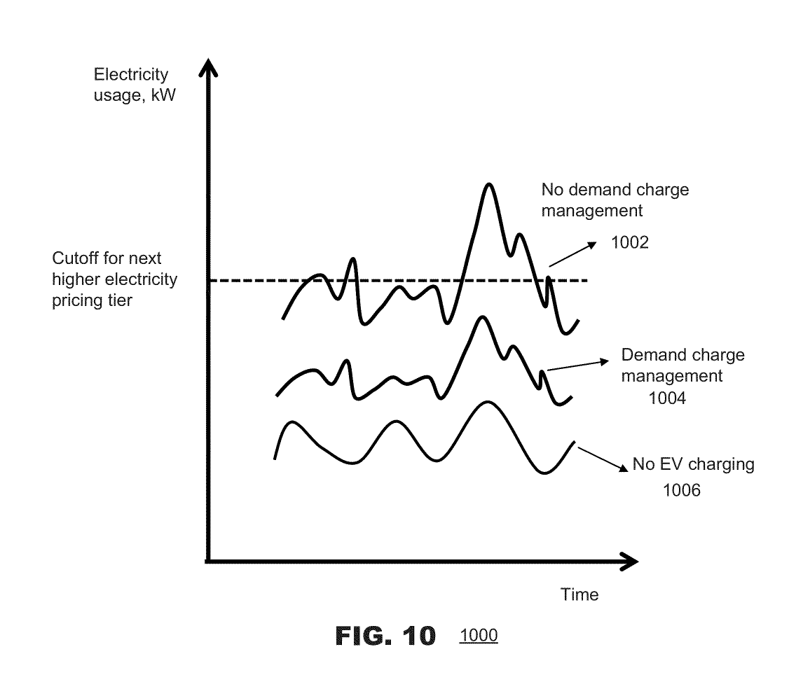

FIG. 10 illustrates electricity usage with demand charge management according to an exemplary embodiment. The curve 1002 may indicate electricity usage when there are no demand charge management. The curve 1004 may indicate electricity usage when there are demand charge management. The curve 1006 may indicate electricity usage when there are no EV charging. As shown in FIG. 10, when there are no demand charge management, electricity usage may pass the cutoff threshold level for a next higher electricity pricing tier when a business add EV charging stations and provide EV charging services. Thus, an embodiment may implement demand charge management policy through cloud-based services. Given a specific address, a driver may be informed of allowed charging level at a particular business address before the driver arrives, and charging level may be enforced through cloud-based communication to the electric vehicle, and to networked EV charging stations located at that business address.

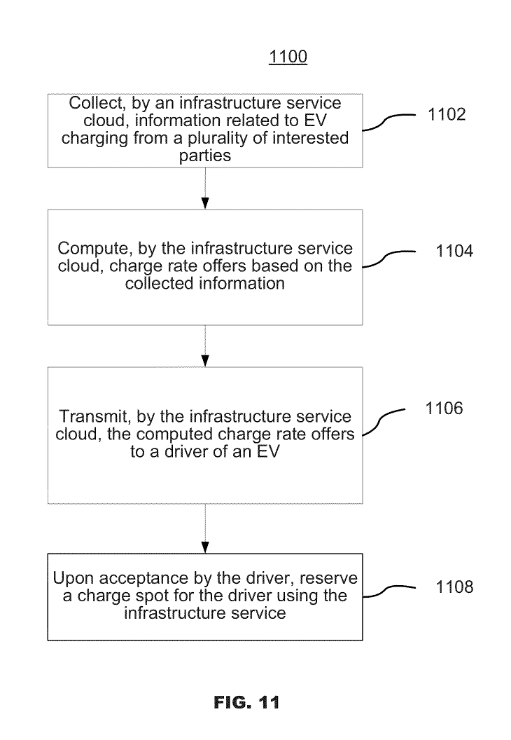

FIG. 11 illustrates a flow chart of a process 1100 for providing economic energy management for charging electric vehicles according to an exemplary embodiment. At block 1102, the process 1100 may collect information related to EV charging from a plurality of interested parties by an infrastructure service cloud. As shown in FIG. 3, the infrastructure service cloud 106 may collect information from the utility cloud 110, from the ESVP cloud 116 and from the retailer cloud 118. In one embodiment, the collection may be in response to a drive sending a request for charging at a public charge station. In another embodiment, the collection may be performed automatically and continuously. At block 1104, the process 1100 may compute one or more charge rate offers based on the collected information by the infrastructure service cloud. The charge rate offers may be computed based on utility prices set by the utility companies, electricity usage at participating retailers, customer profitability at the retailer chain, contract between the retailer chain and OEM, availability of charge spots, etc. In one embodiment, the charge rate offers may include additional offers for store services and goods (e.g., discount for store services and/or goods). At block 1106, the process 1100 may transmit the computed charge rate offers to a driver of an EV by the infrastructure service cloud. As shown in FIG. 1, the driver 102 and the electric vehicle may be coupled to the service cloud 106 via the OEM cloud 108. The OEM cloud 108 may further control transmission between the driver 102 and the infrastructure service cloud 106. At block 1108, the process 1100 may reserve a charge spot for the driver using the infrastructure service when the driver accepts an offer. The acceptance may be transmitted to the infrastructure service cloud 106 and then the infrastructure service cloud 106 may communicate with the EV service provider and retailer to reserve the charge spot selected by the driver.

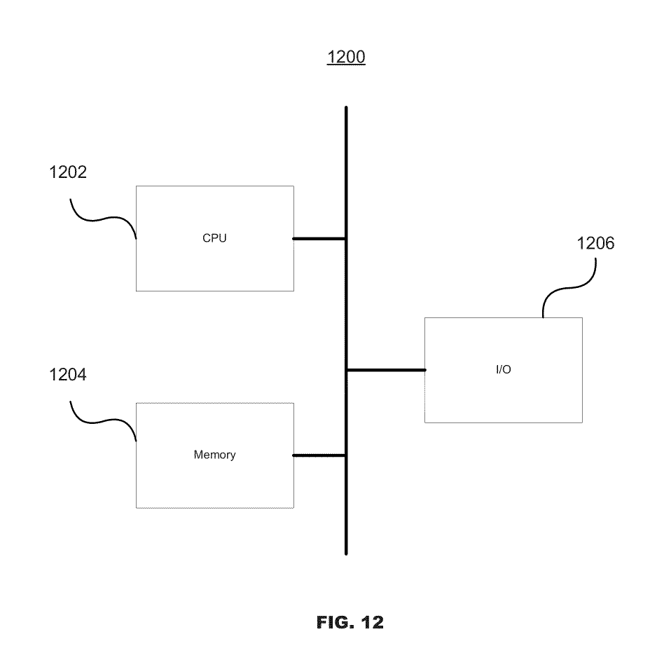

FIG. 12 depicts a structure of a computing device 1200 according to one embodiment of the invention. The computing device 1200 includes a processor 1202, memory 1204, and an I/O device(s) 1206. The processor 1202 is connected to the memory 1204 and I/O device(s) 1206. These connections are direct or via other internal electronic circuitry or components. The computing device 1200 may be a computing device used in the electric vehicle, at the retail store, at a charger spot, and in the various clouds described above.

The processor 1202 is a programmable processor that executes instructions residing in the memory 1204 to receive and send data via the I/O device(s) 1206. The instructions may provide economic energy management for charging electric vehicles at public charging stations as described herein. The term programmable processor as used herein is any programmable microprocessor or processor or combination of microprocessors or processors that can operate on digital data, which may be special or general purpose processors coupled to receive data and instructions from, and to transmit data and instructions to, a machine-readable medium. According to one embodiment of the present invention processor 1202 is an Intel microprocessor.

Memory 1204 is a machine-readable medium that stores data that is processed by processor 1202. The term machine-readable medium as used herein is any addressable storage device that stores digital data including any computer program product, apparatus and/or device (e.g., a random access memory (RAM), read only memory (ROM), magnetic disc, optical disc, programmable logic device (PLD), tape, hard drives, RAID storage device, flash memory or any combination of these devices). This may include external machine-readable mediums that are connected to processor 1202 via one or more I/O device(s) 1206.

The I/O device(s) 1206 may be one or more input/output interfaces that receive and/or send digital data to and from an external device. Interfaces as used herein are any point of access to an external device where digital data is received or sent, including ports, buffers, queues, subsets thereof, or any other interface to an external device.

It should be understood that there exist implementations of other variations and modifications of the invention and its various aspects, as may be readily apparent to those of ordinary skill in the art, and that the invention is not limited by specific embodiments described herein. Features and embodiments described above may be combined with and without each other. It is therefore contemplated to cover any and all modifications, variations, combinations or equivalents that fall within the scope of the basic underlying principals disclosed and claimed herein.

What is claimed is:

1. A method for providing demand charge management, comprising:
collecting, by an infrastructure service cloud, information related to electric vehicle (EV) charging from a plurality of interested parties;
computing, by the infrastructure service cloud, charge rate offers based on the collected information;
transmitting, by the infrastructure service cloud, the computed charge rate offers to a driver of an EV; and
reserving a charge spot for the driver using the infrastructure service when the driver accepts an offer.

2. The method of claim 1, wherein the plurality of interested parties include utility companies, retailer chains, electric vehicle service providers (EVSPs).

3. The method of claim 1, wherein the computed charge rate offers include store coupons for services or goods at a store hosting public charge stations.

4. The method of claim 1, further comprising providing user ratings and direction to charge spots to the driver.

5. The method of claim 1, wherein the charge rate offers are pushed to the driver when the driver drives by without initiating any communication with the infrastructure service.

6. The method of claim 1, wherein the charge rate offers are pushed to the driver in response to the driver sending a request of offers to the infrastructure service.

7. The method of claim 1, further comprising providing to a utility cloud electricity usage for EV charging by the infrastructure service.

8. A non-transitory machine-readable medium storing instructions adapted to be executed by a computer to perform a method comprising:
collecting, by an infrastructure service cloud, information related to electric vehicle (EV) charging from a plurality of interested parties;
computing, by the infrastructure service cloud, charge rate offers based on the collected information;
transmitting, by the infrastructure service cloud, the computed charge rate offers to a driver of an EV; and
reserving a charge spot for the driver using the infrastructure service when the driver accepts an offer.

9. The non-transitory machine-readable medium of claim 8, wherein the plurality of interested parties include utility companies, retailer chains, electric vehicle service providers (EVSPs).

10. The non-transitory machine-readable medium of claim 8, wherein the computed charge rate offers include store coupons for services or goods at a store hosting public charge stations.

11. The non-transitory machine-readable medium of claim 8, further comprising providing user ratings and direction to charge spots to the driver.

12. The non-transitory machine-readable medium of claim 8, wherein the charge rate offers are pushed to the driver when the driver drives by without initiating any communication with the infrastructure service.

13. The non-transitory machine-readable medium of claim 8, wherein the charge rate offers are pushed to the driver in response to the driver sending a request of offers to the infrastructure service.

14. The non-transitory machine-readable medium of claim 8, further comprising providing to a utility cloud electricity usage for EV charging by the infrastructure service.

15. A computer system for a price simulation, comprising:
a memory to store computer program instructions; and
a processor coupled to the memory to execute the computer program instructions to:
collect information related to electric vehicle (EV) charging from a plurality of interested parties by an infrastructure service cloud;
compute charge rate offers based on the collected information by the infrastructure service cloud;
transmit the computed charge rate offers to a driver of an EV by the infrastructure service cloud; and
reserve a charge spot for the driver using the infrastructure service when the driver accepts an offer.

16. The computer system of claim 15, wherein the plurality of interested parties include utility companies, retailer chains, electric vehicle service providers (EVSPs).

17. The computer system of claim 15, wherein the computed charge rate offers include store coupons for services or goods at a store hosting public charge stations.

18. The computer system of claim 15, further comprising providing user ratings and direction to charge spots to the driver.

19. A method for providing demand charge management, comprising:
collecting, by an infrastructure service cloud, information related to electric vehicle (EV) charging from a plurality of interested parties, wherein the plurality of interested parties include at least utility companies, retailer chains, electric vehicle service providers (EVSPs);
computing, by the infrastructure service cloud, charge rate offers based on the collected information, wherein the computed charge rate offers include store coupons for services or goods at a store hosting public charge stations;
transmitting, by the infrastructure service cloud, the computed charge rate offers to a driver of an EV; and
reserving a charge spot for the driver using the infrastructure service when the driver accepts an offer.

20. The method of claim 1, further comprising providing to a utility cloud electricity usage for EV charging by the infrastructure service.
